(19) United States
(12) Patent Application Publication
(10) Pub. No.: US 2020/0243828 A1
(43) Pub. Date: Jul. 30, 2020

(54) LITHIUM SECONDARY BATTERY WITH POROUS NANOFIBER COATED ELECTRODE AND METHOD

(71) Applicant: Amperex Technology Limited, Tsuen Wan N.T. (HK)

(72) Inventors: Chi Ho Kwok, Science Park (HK); Ka I Lee, Science Park (HK); Wai Chung Li, Science Park (HK); Shengbo Lu, Science Park (HK); Nga Yu Hau, Science Park (HK); Wing Lung HON, Science Park (HK); Chenmin Liu, Science Park (HK)

(21) Appl. No.: 16/750,032

(22) Filed: Jan. 23, 2020

Related U.S. Application Data
(60) Provisional application No. 62/918,288, filed on Jan. 25, 2019.

(51) Int. Cl. H01M 2/16; H01M 10/0525; H01M 4/62; H01M 4/36

(52) U.S. Cl. CPC H01M 2/1673; H01M 10/0525; H01M 4/366; H01M 2/162; H01M 4/62; H01M 2/1646

(57) ABSTRACT

This patent application discloses a lithium secondary battery and methods of making and the same and use thereof. The lithium secondary battery has a cathode including a cathode active material, an anode including an anode active material, and an electrolyte solution including a lithium salt. A coating including a layer of fine polymer fibers is formed on a surface of at least one side of the cathode, the anode, or both the cathode and the anode. The coating having an area larger than the surface of the cathode, anode, or both the cathode and anode, extending to each edge of the at least one side of the cathode, the anode, or both the cathode and the anode.

### CROSS-REFERENCE TO PRIOR APPLICATIONS

This application claims the benefit of U.S. provisional Application No. 62/918,288, filed on Jan. 25, 2019, the teaching of which is hereby incorporated by reference in its entirety.

### BACKGROUND

### A. Technical Field

The present invention relates to a lithium secondary battery and methods of making and using the same.

### B. Background of the Invention

Lithium-ion (Li-ion) batteries (hereafter also referred to as “LIB”) are used in a growing number of applications, including portable elec-tronics, medical, transportation, grid-connected large energy storage, renewable energy storage, and uninterruptible power supply (UPS). Additionally, in many applications, there is a need for miniaturization of the UPS unit, for example, the UPS unit in a medical implant.

Li-ion batteries typically include an anode electrode, a cathode electrode and a separator positioned between the anode electrode and the cathode electrode. The separator is an electronic insulator which provides physical and electrical separation between the cathode and the anode electrodes. The separator is typically made from micro-porous polyethylene and polyolefin, and is applied in a separate manufacturing step. During electrochemical reactions, i.e., charging and dis-charging, Li-ions are transported through the pores in the separator between the two electrodes via an electrolyte. Thus, high porosity is desirable to increase ionic conductivity. However, some high porosity separators are susceptible to electrical shorts when lithium dendrites formed during cycling create shorts between the electrodes.

FIG. 1 shows a typical lithium ion battery (“LIB”) 100, which includes a cathode 200, an anode 300, a separator 400, and electrolyte having lithium ions 500. During charging, lithium ions 500 move from cathode 200 to anode 300 across separator 400 through pores 410, and absorb electrons from an external source of electricity. In use, the LIB discharges, and the lithium atoms lose electrons at anode 300. The electrons drive an external load, and the lithium ions 500 move back toward cathode 200.

Currently, battery cell manufacturers purchase separators, which are then laminated together with anode and cathode electrodes in separate processing steps. Other separators are made by wet or dry extrusion of a polymer and then stretched to produce holes (tears) in the polymer. The separator is also one of the most expensive components in the Li-ion battery and accounts for over 20% of the material cost in battery cells.

For most energy storage applications, the charge time and capacity of energy storage devices are important parameters. In addition, the size, weight, and/or expense of such energy storage devices can be significant limitations. The use of current separators has a number of drawbacks. Namely, such materials limit the minimum size of the electrodes constructed from such materials, suffer from electrical shorts, require complex manufacturing methods, and expensive materials.

Accordingly, there is a need in the art for faster charging, higher capacity energy storage devices that are smaller, lighter, safer and can be more cost effectively manufactured.

### SUMMARY OF THE DISCLOSURE

In an aspect, embodiments of the present invention provide a lithium secondary battery (“LIB”), the LIB including a cathode including a cathode active material, an anode including an anode active material, and an electrolyte solution including a lithium salt, wherein a coating including a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

In some embodiments, optionally in combination with any or all the various embodiments of the LIB disclosed herein, the LIB is a separator-free battery that does not include a standalone separator.

In some embodiments, optionally in combination with any or all the various embodiments of the LIB disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the LIB disclosed herein, the coating is formed on one side or both side of both the cathode and the anode.

In some embodiments, optionally in combination with any or all the various embodiments of the LIB disclosed herein, the coating including the layer of fine polymer fibers is formed by depositing on the surface of cathode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the LIB disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof, wherein the filling agent is suspended in the polymer solution forming a homogenous suspension formulation with the polymer solution, and wherein the filling agent has a weight percentage greater than 0 wt % but less than 30 wt % of the suspension formulation.

In some embodiments, optionally in combination with any or all the various embodiments of the LIB disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the LIB disclosed herein, the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF

In some embodiments, optionally in combination with any or all the various embodiments of the LIB disclosed herein, the coating is formed on one side or both sides of the cathode, the nanofibers being connected via 4 edges of the cathode surface; and wherein the layer of the nanofibers has a bulk volume porosity in a range of from about 40 to about 90%.

In some embodiments, optionally in combination with any or all the various embodiments of the LIB disclosed herein, the coating has a thickness in a range from about 5 μm to about 50 μm.

In another aspect of the present invention, it is provided a method of

fabricating a lithium secondary battery, including:

providing a cathode including a cathode active material,

providing an anode including a anode active material,

providing an electrolyte solution including a lithium salt dissolved therein,

forming a coating including a layer of fine polymer fibers on a surface of the cathode, the anode, or both the cathode and anode, and

forming the lithium secondary battery.

In some embodiments, optionally in combination with any or all the various embodiments of the method disclosed herein, wherein forming the coating further includes hot pressing the layer of fine polymer fibers.

In some embodiments, optionally in combination with any or all the various embodiments of the method disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof,

wherein the filling agent is suspended in the polymer solution forming a homogenous suspension formulation with the polymer solution, and

wherein the filling agent has a weight percentage greater than 0 wt % but less than 30 wt % of the suspension formulation.

In some embodiments, optionally in combination with any or all the various embodiments of the method disclosed herein, the polymer is a wherein the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the method disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the method disclosed herein, the coating is formed on one side or both side of both the cathode and the anode.

In some embodiments, optionally in combination with any or all the various embodiments of the method disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the method disclosed herein, the LIB is a separator-free battery that does not include a standalone separator.

In some embodiments, optionally in combination with any or all the various embodiments of the method disclosed herein, the coating is formed on one side or both sides of the cathode, the nanofibers being connected via 4 edges of the cathode surface; and wherein the layer of the nanofibers has a bulk volume porosity in a range of from about 40 to about 90%.

In some embodiments, optionally in combination with any or all the various embodiments of the method disclosed herein, the coating has a thickness in a range from about 5 μm to about 50 μm.

In another aspect of the present invention, it is provided an article of manufacture, the article including a lithium secondary battery, the lithium secondary battery including a cathode including a cathode active material, an anode including an anode active material, and an electrolyte solution including a lithium salt, wherein a coating including a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

In some embodiments, optionally in combination with any or all the various embodiments of the article disclosed herein, the coating including the layer of fine polymer fibers is formed by depositing on the surface of cathode or surface of anode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the article disclosed herein, the LIB is a separator-free battery that does not include a standalone separator.

In some embodiments, optionally in combination with any or all the various embodiments of the article disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the article disclosed herein, the coating is formed on one side or both side of both the cathode and the anode.

In some embodiments, optionally in combination with any or all the various embodiments of the article disclosed herein, the coating including the layer of fine polymer fibers is formed by depositing on the surface of cathode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the article disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof,

wherein the filling agent is suspended in the polymer solution forming a homogenous suspension formulation with the polymer solution, and

wherein the filling agent has a weight percentage greater than 0 wt % but less than 30 wt % of the suspension formulation.

In some embodiments, optionally in combination with any or all the various embodiments of the article disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the article disclosed herein, the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF.

In some embodiments, optionally in combination with any or all the various embodiments of the article disclosed herein, the coating is formed on one side or both sides of the cathode, the nanofibers being connected via 4 edges of the cathode surface; and wherein the layer of the nanofibers has a bulk volume porosity in a range of from about 40 to about 90%.

In some embodiments, optionally in combination with any or all the various embodiments of the article disclosed herein, the coating has a thickness in a range from about 5 μm to about 50 μm.

In some embodiments, optionally in combination with any or all the various embodiments of the article disclosed herein, the article is an automobile, a portable electronic device such as a smart phone, a wearable watch, a notepad such as iPad, a computer, a medical device, an implantable device, wearable equipment, a robot, or an energy storage device other than battery.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates structural elements of a prior art lithium ion battery.

FIG. 2 illustrates an embodiment of the nanofiber coating formed on both sides of cathode.

FIG. 3 illustrates an embodiment of the nanofiber coating formed on both sides of cathode surface and sealed at each edge of the cathode.

FIG. 4A shows the performance of an embodiment of battery with 10.0-15.0 μm nanofiber coating on anode and cathode.

FIG. 4B shows the performance of an embodiment of battery with 20.0 μm nanofiber coating on anode and cathode.

FIG. 5 shows nanofibers coated on an electrode.

FIG. 6 shows the results of studies on discharge capacity at different C-rates of battery of invention.

FIG. 7 shows the results of self-discharge studies on embodiments of invention batteries.

FIG. 8 shows the results of long term battery performance studies on embodiments of batteries of invention.

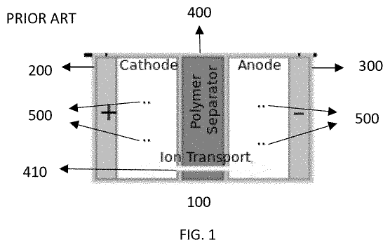

### DETAILED DESCRIPTION OF THE PREFERRED EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways.

Elements/components shown in diagrams are illustrative of exemplary embodiments of the disclosure and are meant to avoid obscuring the disclosure. Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” or “in embodiments” in various places in the specification are not necessarily all referring to the same embodiment or embodiments. The terms “include,” “including,” “include,” and “including” shall be understood to be open terms and any lists that follow are examples and not meant to be limited to the listed items. Any headings used herein are for organizational purposes only and shall not be used to limit the scope of the description or the claims. Furthermore, the use of certain terms in various places in the specification is for illustration and should not be construed as limiting.

As used herein, the term “ceramic precursor” refers to an inorganic, organic, or polymer material capable of forming ceramic nanofiber coatings disclosed herein. In this context, whenever used, the term “polymer precursor” refers to a polymer material that undergoes chemical transformation and forms a nanofiber coating disclosed herein.

As used herein, the term “dual polymer” refers to a combination of two different polymer materials forming nanofiber coatings disclosed herein.

As used herein, the term “nanofiber” is used interchangeably with the term “NF coating.”

### Lithium Secondary Battery

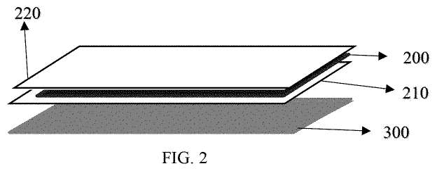

The present application discloses a new type of lithium ion battery structure with separator free, high flexibility, smart safety control as features. The battery has 1) a thin layer of nanofiber coating on either or both side of the anode/cathode surface, 2) with the nanofiber encapsulating substantially the whole electrode to form a porous electrode cage. The structure can further reduce the thickness of the battery as separator was eliminated and increase the uptake and affinity of the electrolyte by nanofibers, with high porosity to facilitate the lithium ion transportation, which can stabilize the battery operation. The as-coated porous electrode can also serve as a highly porous and increase the puncture strength of the electrode. The nanofiber coating can also serve as a jacket which sealed at 4 edges, preventing the internal short circuit to occur between the close contact of anode and cathode (see FIG. 2). A lithium secondary battery of this design and configuration would possess enhanced safety when exposed to heating. This is especially important as a lithium secondary batter would undergo temperature increase and pressure buildup when short circuit occurs, e.g., thermal runaway, and, in such situations, the separator film or coating on an electrode would shrink, and the increased pressure would further squeeze the anode and cathode so as to thermal runaway, fire, or even explosion.

In an aspect, embodiments of the present invention provide a lithium secondary battery (“LIB”), the LIB including a cathode including a cathode active material, an anode including an anode active material, and an electrolyte solution including a lithium salt, wherein a coating including a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

In some embodiments, optionally in combination with any or all the various embodiments of the LIB disclosed herein, the LIB is a separator-free battery that does not include a standalone separator.

In some embodiments, optionally in combination with any or all the various embodiments of the LIB disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the LIB disclosed herein, the coating is formed on one side or both side of both the cathode and the anode.

In some embodiments, optionally in combination with any or all the various embodiments of the LIB disclosed herein, the coating including the layer of fine polymer fibers is formed by depositing on the surface of cathode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the LIB disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof,

wherein the filling agent is suspended in the polymer solution forming a homogenous suspension formulation with the polymer solution, and

wherein the filling agent has a weight percentage greater than 0 wt % but less than 30 wt % of the suspension formulation.

In some embodiments, optionally in combination with any or all the various embodiments of the LIB disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the LIB disclosed herein, the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF. Some other examples of polymers are carboxymethyl cellulose (CMC), Nylon-6, 6, Polyacrylic acid (PAA), Polyvinyl alcohol (PVA), Polylacetic acid (PLA), Polyethylene-co-vinyl acetate, PEVA/PLA, Polymethyacrylate (PMMA)/tetrahydroperfluorooctylacrylate (TAN), Polyethylene oxide (PEO), Polymethacrylate (PMMA), Polyamide (PA), Poly-caprolactone (PCL), Polyethyl imide (PEI) Polycaprolactam, Polyethylene (PE), Polyethylene terephthalate (PET), Polyolefin, Polyphenyl ether (PPE), Polyvinyl chloride (PVC), Polyvinylidene chloride (PVDC), Polyvinylidene fluoride (PVDF), Poly(vinylidenefluoride-co-hexafluoropropylene (PVDF-HFP), Polyvinyl-pyridine, Polylactic acid (PLA), Polypropylene (PP), Polybutylene (PB), Polybutylene terephthalate (PBT), Polyamide (PA), Polyimide (PI), Poly-carbonate (PC), Polytetrafluoroethylene (PTFE), Polystyrene (PS), Polyester (PE), Acrylonitrile butadiene styrene (ABS), Poly(methyl methacrylate) (PMMA), Polyoxymethylene (POM), Polysulfone (PES), Styrene-acrylonitrile (SAN), Polyacrylonitrile (PAN), Styrene-butadiene rubber (SBR), Ethylene vinyl acetate (EVA), Styrene maleic anhydride (SMA), and combinations thereof. The polymer may com-prise from about 0.5 wt. % and about 30 wt % of the total weight of the separator forming solution.

In some embodiments, optionally in combination with any or all the various embodiments of the LIB disclosed herein, the coating is formed on one side or both sides of the cathode, the nanofibers being connected via 4 edges of the cathode surface; and

wherein the layer of the nanofibers has a bulk volume porosity in a range of from about 40 to about 90%.

In some embodiments, optionally in combination with any or all the various embodiments of the LIB disclosed herein, the coating has a thickness in a range from about 5 μm to about 50 μm.

Cathode Active Materials

Cathode Active Materials are the main elements dictating the differences in composition while building positive electrodes for battery cells. The cathode materials are included of cobalt, nickel and manganese in the crystal structure forming a multi-metal oxide material to which lithium is added. This family of batteries includes a variety of products that cater to different user needs for high energy density and/or high load capacity. Table 1 summarizes some common batteries, their respective chemistries, specifications, and applications. Examples

TABLE 1

| | | | | | Charge & | Energy | |
|---|---|---|---|---|---|---|---|
| | | | Charge V | | Discharge | Density | |
| Chemistry | Nominal V | | limit | | C-rates | Wh/kg | Applications |
| Cobalt | 3.60 | V | 4.20 | V | 1 C limit | 110-190 | Cell phone, cameras, |
| | | | | | | | laptops |
| Manganese | 3.7-3.80 | V | 4.20 | V | 10 C cont. | 110-120 | Power tools, medical |
| | | | | | 40 C pulse | | equipment |
| NCM | 3.70 | V | 4.10 | V* | ~5 C cont. | 95-130 | Power tools, medical |
| (nickel-cobalt | | | | | 30 C pulse | | equipment |
| manganese) | | | | | | | |
| Phosphate | 3.2-3.30 | V | 3.60 | V* | 35 C cont. | 95-140 | Power tools, medical |
| | | | | | | | equipment |

*Higher voltages provide more capacity hut reduce cycle life
NMC (NCM)—Lithium Nickel Cobalt Manganese Oxide (LiNiCoMnO2)
LFP—Lithium Iron Phosphate (LiFePO4/C)
NCA—Lithium Nickel Cobalt Aluminium Oxide (LiNiCoAlO2)
LMO—Lithium Manganese Oxide (LiMn2O4)
LNMO—Lithium Nickel Manganese Spinel (LiNi0.5Mn1.5O4)
LCO—Lithium Cobalt Oxide (LiCoO2)

of cathode active material includes lithium-transition metal composite oxides include LiCoO₂, LiNi1-xCoxO₂ (0<x<0.3), LiMnxNiyCo_{z}O₂ (0<x<0.5, 0<y<0.5, 0≤z≤0.5), LiMn₂₋ₓMₓO₄ (M represents Li, Mg, Co, Al, or Ni, 0<x<0.2), and LiMPO₄ (M represents Fe, Co, or Ni). Further examples of lithium salts used in the lithium secondary battery of the present invention are LiPF₆, LiClO₄, LiAsF₆, LiBF₄ or LiCF₃SO₃. Other examples include lithium cobalt dioxide (LiCoO₂), lithium manganese dioxide (LiMnO₂), titanium disulfide (TiS₂), LiNixCO₁₋₂ₓMnO₂, LiMn₂O₄, LiFePO₄, LiFe₁₋ₓMgPO₄, LiMoPO₄, LiCoPO₄, Li₃ViPO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅Vi(PO₄)₂F₃, Li₂FeSiO₄, Li₂MnSiO₄, Li₂VOSiO₄, LiNiO₂, and combinations thereof.

Anode Active Materials

Anode of lithium-ion battery is typically made up of graphite, coated on a metal foil such as copper foil or aluminum foil or tin/silicon type alloys. Graphite is a crystalline solid with a black/grey color and a metallic sheen. Due to its electronic structure, it is highly conductive and can reach 25,000 S/cm² in the plane of a single-crystal. Graphite is commonly used as the active material in negative electrodes mainly because it can reversibly place Lithium-ions between its many layers. This reversible electrochemical capability is maintained over several of thousands of cycles in batteries with optimized electrodes. However, one requirement for this application is that the Graphite surface must be compatible with Lithium-ion battery chemistry (salts, solvents and binders).

Binders

Binder materials are used to hold the active material particles within the electrode of a lithium-ion battery (LIB) together to maintain a strong connection between the electrode and the contacts. Binders for the positive cathode also need to be resistant to oxidation. For example, styrene butadiene copolymer (SBR) and polyvinylidene fluoride (PVDF) are used in the cathode and anode electrode slurry making process for lithium-ion batteries. Other types binders are being developed to meet the evolving needs of the lithium-ion battery manufacturing industry, e.g., to provide higher energy density or to provide a longer per charge mileage.

Separator

The LIB disclosed herein can optionally include a separator. A separator is a permeable membrane placed between a battery's anode and cathode. The main function of a separator is to keep the two electrodes apart to prevent electrical short circuits while also allowing the transport of ionic charge carriers that are needed to close the circuit during the passage of current in an electrochemical cell. Separator films generally used by the industry are polyethylene (PE) and polypropylene (PP) based, however, the LIB using PP/PE separator film has common problems such as instability of battery performance, intricacy of its fabrication process, restriction of battery shape, the affinity of electrolyte and etc.

In an effort to minimize battery dimension, embodiments of the present invention provide a lithium ion battery having a nanofiber coating on an electrode as an integral part of the electrode so that a separate separator element is no longer needed (separator-free). A separator-free lithium battery, however, is still required to retain the following essential properties of a separator:

Chemical stability—The nanofiber coating material must be chemically stable against the electrolyte and electrode materials under the strongly reactive environments when the battery is fully charged. The separator should not degrade.
Thickness—The nanofiber coating must be thin to facilitate the battery's energy and power densities. A nanofiber coating that is too thin can compromise mechanical strength and safety. Thickness should be uniform to support many charging cycles.
Porosity—The nanofiber coating must have sufficient pore density to hold liquid electrolyte that enables ions to move between the electrodes. Excessive porosity hinders the ability of the pores to close, which is vital to allow the separator to shut down an overheated battery. The pores on the nanofiber coating must have a pore size that is smaller than the particle size of the electrode components, including the active materials and conducting additives.
Permeability—Nanofiber coating will increase the resistance of the electrolyte by a factor of four to five as does a separator. The ratio of the resistance of the electrolyte-filled separator to the resistance of the electrolyte alone is called the MacMullin number. Air permeability can be used indirectly to estimate the MacMullin number. Air permeability is expressed in terms of the Gurley value, the time required for a specified amount of air to pass through a specified area of the separator under a specified pressure.
Mechanical strength—The nanofiber coating must be strong enough to withstand the tension of the winding operation during battery assembly.
Wettability—The electrolyte must fill the entire battery assembly, requiring the nanofiber coating to “wet” easily with the electrolyte. Furthermore, the electrolyte should be able to permanently wet the nanofiber coating, preserving the cycle life.
Thermal stability—The nanofiber coating must remain stable over a wide temperature range.
Thermal shutdown—The nanofiber coatings in lithium-ion batteries must offer the ability to shut down at a temperature slightly lower than that at which thermal runaway occurs, while retaining its mechanical properties.

Nanofiber Coating Materials

Materials for forming the nanofiber coating disclosed herein can be formed of a polymer, which possesses properties suitable for battery. For example, the polymer must be inert such that it would not undergo oxidation under charging or discharging conditions. Additionally, the polymer must have a molecular weight high enough such that fibers formed thereof can form a coating on battery cathode or anode maintaining a porosity of a size large enough to allow lithium ion transportation and a degree of porosity sufficiently high to allow sufficient transportation of lithium ions in charging and discharging. Additionally, the polymer must have sufficient mechanical strength to allow fibers formed therefrom to maintain its structural integrity. Some examples of polymers are shown in the table below (Table 2). Other examples of polymers are polyamideimide, polyamide, polyolefin, polyether, polyimide, polyketone, polysulfone, cellulose, polyvinyl alcohol (PVA), and polyvinylidene fluoride (PVdF). Examples of polyolefin include polypropylene (PP) and polyethylene (PE).

TABLE 2

| | | | PAN | PI |
|---|---|---|---|---|
| | PVDF | PVDF-HFP | (polyacrylonitrile) | (polyimide) |
| Molecular weight | 300,000-330,000 | 570,000-600,000 | 150,000 | TBC (data |
| | | | | not shown) |
| Melting point | 170-175 | 130-136 | 317 | No melting |
| (° C.) | | | | point |
| Glass transition | −40 | −40 | 85 | 315 |
| (° C.) | | | | |

Filling Agent

In some embodiments, the nanofiber coating can optionally include a filling agent (also referred to as “filler”). Filling agents are used to create porosity and/or maintain a degree of porosity and to enhance mechanical strength including durability and/or structural integrity and penetration strength. Examples of filling agents include, TiO₂, LiO₂, BaO, MgO, SiO₂, Al₂O₃, PTFE (polytetrafluoroethylene), ceramics, and a mixture thereof. Exemplary ceramic materials include BaTiO₃, HfO₂ (hafnia), SrTiO₃, ZrO₂ (zirconia), SnO₂, CeO₂, MgO, CaO, Y₂O₃, CaCO₃, and combinations thereof. In one embodi-ment, the ceramic particles are selected from the group including SiO₂, Al₂O₃, MgO, and combinations thereof.

The size of the ceramic particles may be selected such that the particle size is less than the diameter of the polymer fibers and the particles will not clog the deposition system. In cer-tain embodiments, the ceramic particles may have a particle size between about 5 nm to about 0.3 μm. The particles may be less than 300 nm in diameter, or less than 100 nm in diameter, and more typically from about 10-20 nm in diam-eter. The small particle size of the ceramic particles makes it more difficult for lithium dendrites formed during the cycling process from growing through the separator and causing shorts.

Ceramic particles may be added to the polymer solution using a sol-gel process. In a sol-gel process, inorganic pre-cursors (AKA ceramic precursors) are added to the polymer solution and react to form ceramic particles in the polymer solution. For example, inorganic precursors such as TiCl₄ and Ti(OH)₄ are added to the polymer solution and react to form TiO₂ sol particles. Thus, the precursors for the ceramic particles are added to the polymer solution. The ceramic particles may form as the precur-sors are mixed or in some cases, the precursors may require heating the mixture or heating the fibers after they have been electrospun. The heating temperature will be less than the melting temperature of the polymer fibers.

Additives

In some embodiments, the nanofiber coating can optionally include an additive. Such additive(s) can be added in the process of forming the nanofiber coating to impart or modify the properties of the nanofiber coating, e.g., to maintain porosity, pore structure, nanofiber coating structure, and/or to increase adhesion of the nanofiber coating to surface of the cathode or anode. Generally, such additives can be, e.g., cross-linking agents and/or nanofiber surface modifiers and/or cathode or anode surface modifiers. An example of such additive is tetramethyl orthosilicate (TMOS) or tetraethyl orthosilicate (TEOS).

In some embodiments, an additive can be one of the filling agents described above, e.g., a ceramic additive or ceramic precursor.

### Method of Fabrication

In another aspect of the present invention, it is provided a method of

fabricating a lithium secondary battery, including:

providing a cathode including a cathode active material,

providing an anode including a anode active material,

providing an electrolyte solution including a lithium salt dissolved therein,

forming a coating including a layer of fine polymer fibers on a surface of the cathode, the anode, or both the cathode and anode, and

forming the lithium secondary battery.

In some embodiments, optionally in combination with any or all the various embodiments of the method disclosed herein, wherein forming the coating further includes hot pressing the layer of fine polymer fibers.

In some embodiments, optionally in combination with any or all the various embodiments of the method disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof,

wherein the filling agent is suspended in the polymer solution forming a homogenous suspension formulation with the polymer solution, and

wherein the filling agent has a weight percentage greater than 0 wt % but less than 30 wt % of the suspension formulation.

In some embodiments, optionally in combination with any or all the various embodiments of the method disclosed herein, the polymer is a wherein the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the method disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the method disclosed herein, the coating is formed on one side or both side of both the cathode and the anode.

In some embodiments, optionally in combination with any or all the various embodiments of the method disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the method disclosed herein, the LIB is a separator-free battery that does not include a standalone separator.

In some embodiments, optionally in combination with any or all the various embodiments of the method disclosed herein, the coating is formed on one side or both sides of the cathode, the nanofibers being connected via 4 edges of the cathode surface; and wherein the layer of the nanofibers has a bulk volume porosity in a range of from about 40 to about 90%.

In some embodiments, optionally in combination with any or all the various embodiments of the method disclosed herein, the coating has a thickness in a range from about 5 m to about 50 μm. In some embodiments, the coating has a thickness of about 10 μm.

In some embodiments, optionally in combination with any or all the various embodiments of the method disclosed herein, forming a coating is by an electrospinning technology.

The organic solvent can be any solvents capable of forming an organic electrolyte. Examples of the organic solvent used in the organic electrolyte solution can include ethylene carbonate, propylene carbonate, diethyl carbonate, dimethyl carbonate, ethylmethyl carbonate or mixtures thereof. In order to improve the low-temperature characteristic of the battery, methyl acetate, methyl propionate, ethyl acetate, ethyl propionate, butylenecarbonate, γ-butyrolactone, 1,2-dimethoxyethane, 1,2-dimethoxyethane, dimethyl-acetamide, tetrahydrofuran or mixtures thereof can be further added to the organic solvent.

Electrospinning Technology

A preferred method of making nanofibers disclosed herein is electrospinning technology to develop a thin and flexible multi-porous nanofiber coating on the electrode surface. The coating thus formed can take the advantages of the nanofibers, such as, 1) high porosity, 2) high electrolyte uptake and affinity, 3) thin, 4) flexible and etc. Specialized controlled formula will be developed to provide a better adhesion of nanofibers to the electrode surface so that it can stabilize the performance of the battery during charge and discharge cycle.

Electrospinning is a fiber production method which uses electric force to draw charged threads of polymer solutions or polymer melts up to fiber diameters in the order of some hundred nanometers (see, e.g., Ziabicki, A. (1976) Fundamentals of fiber formation, John Wiley and Sons, London, ISBN 0-471-98220-2; Li, D.; Xia, Y. (2004). “Electrospinning of Nanofibers: Reinventing the Wheel?”. Advanced Materials. 16 (14): 1151-1170).

When a sufficiently high voltage is applied to a liquid droplet, the body of the liquid becomes charged, and electrostatic repulsion counteracts the surface tension and the droplet is stretched; at a critical point a stream of liquid erupts from the surface. This point of eruption is known as the Taylor cone. If the molecular cohesion of the liquid is sufficiently high, stream breakup does not occur (if it does, droplets are electrosprayed) and a charged liquid jet is formed. As the jet dries in flight, the mode of current flow changes from ohmic to convective as the charge migrates to the surface of the fiber. The jet is then elongated by a whipping process caused by electrostatic repulsion initiated at small bends in the fiber, until it is finally deposited on the grounded collector. The elongation and thinning of the fiber resulting from this bending instability leads to the formation of uniform fibers with nanometer-scale diameters (Id.).

Parameters of electrospinning technology generally include: molecular weight, molecular-weight distribution and architecture (branched, linear etc.) of the polymer; solution properties (viscosity, conductivity and surface tension); electric potential, flow rate and concentration; distance between the capillary and collection screen; ambient parameters (temperature, humidity and air velocity in the chamber); motion and size of target screen (collector); and needle gauge.

Electrospinning technology has been used in forming coatings on an electrode (see, e.g., U.S. Pat. No. 9,065,122 B2 to Orilall et al., U.S. Pat. No. 9,138,932 B2 to Huang, and U.S. Pat. No. 7,279,251B1 to Yun et al.) and various electrospinning apparatus for use in LIB making are further described in, for example, US patent application publication No. 2018202074A1 and Chinese Patent No. CN101192681B.

Electrospinning technology can use a melted polymer or a polymer solution. If electrospinning uses a polymer solvent, solvents usable for forming nanofibers of polymers can be any solvents capable of dissolving or substantially dissolving such polymers. Examples of the organic solvent include propylene carbonate, butylene carbonate, 1,4-butyrolactone, diethyl carbonate, dimethyl carbonate, 1,2-dimethoxyethane, 11,3-dimethyl-2-imidazoldinone, dimethylsulfoxide, ethylene carbonate, ethymethyl carbonate, N,N-dimethylformamide, N,N-dimethylacetamide, N-methyl-2-pyrrolidone, polyethylenesulforane, tetra-ethylene glycol dimethyl ether, acetone, alcohol or mixtures thereof.

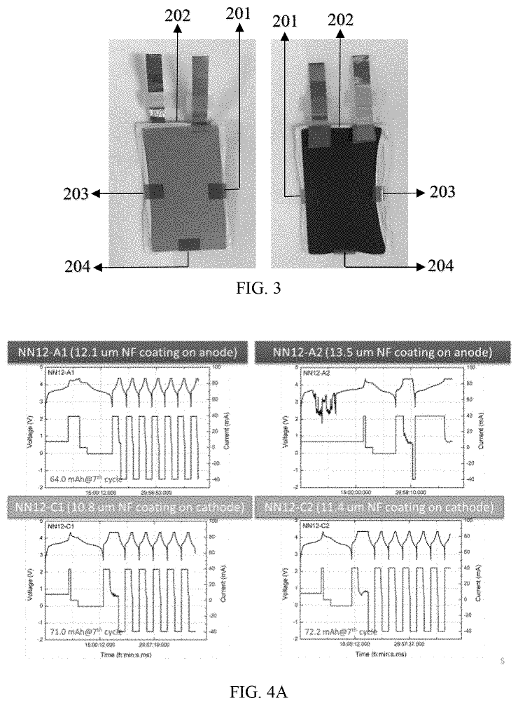

FIG. 3 illustrates an embodiment of the nanofiber coating formed on cathode surface with a thin layer of nanofiber was formed on both cathode surfaces and a nanofiber pocket was formed which was sealed at 4 edges 201, 202, 203, and 204. Cross sectional SEM was used to characterize the surface perfectness of the nanofiber coating. From the SEM results (data not shown), it was found that the average thickness of the nanofiber layer is about 12.5 μm for anode and 13.5 μm for cathode. The nanofiber coating on cathode surface was satisfactory with good adhesion and laminated on the electrode surface. It was found that battery with a thin nanofiber layer (ca. 2.0-3.0 μm) nanofiber coating (either on cathode, on anode or both) was failed and difficult to charge up under standard condition. Further increase the thickness of the nanofiber to 10.0-20.0 μm, the lithium ion battery was resumed to the original performance, showing a normal charge up and discharge cycling (data not shown).

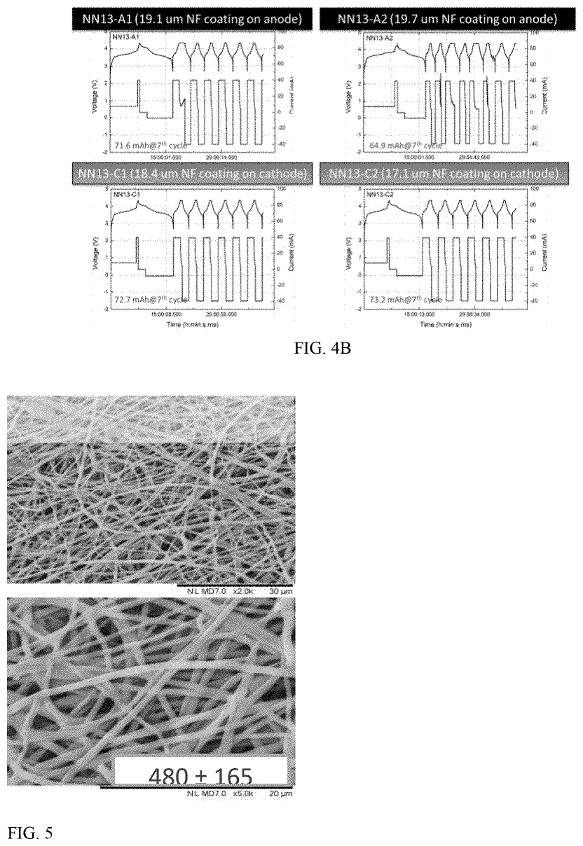

FIG. 4A and FIG. 4B show the charge/discharge performance diagram of the as prepared electrode (FIG. 4A: 10.8 μm and 11.4 μm NF coatings on cathode, 12.1 μm and 13.5 μm NF coatings on anode; FIG. 4B: 19.1 μm and 19.7 μm NF coatings on anode, 18.4 μm and 17.1 μm NF coatings on cathode). From the test data, it was found that the impedance of the separator free design is lower than that of the battery using typical commercial separator (PP/PE) which showed the advantages in using nanofiber coated electrode instead of commercial separator, such as the high affinity to electrolyte, good adhesion to the electrode surface, high porosity facilitate the lithium ion transportation and etc.

### Article of Manufacture

In another aspect of the present invention, it is provided an article of manufacture, the article including a lithium secondary battery, the lithium secondary battery including a cathode including a cathode active material, an anode including an anode active material, and an electrolyte solution including a lithium salt, wherein a coating including a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

In some embodiments, optionally in combination with any or all the various embodiments of the article disclosed herein, the coating including the layer of fine polymer fibers is formed by depositing on the surface of cathode or surface of anode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the article disclosed herein, the LIB is a separator-free battery that does not include a standalone separator.

In some embodiments, optionally in combination with any or all the various embodiments of the article disclosed herein, the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

In some embodiments, optionally in combination with any or all the various embodiments of the article disclosed herein, the coating is formed on one side or both side of both the cathode and the anode.

In some embodiments, optionally in combination with any or all the various embodiments of the article disclosed herein, the coating including the layer of fine polymer fibers is formed by depositing on the surface of cathode a melted polymer or polymer mixture or a solution of a polymer or polymer mixture in an organic solvent and allowing the melted polymer or polymer mixture to cool or the organic solvent to evaporate so as to form a coating including a layer of fine polymer fibers.

In some embodiments, optionally in combination with any or all the various embodiments of the article disclosed herein, the polymer solution further includes an optional additive and a filling agent selected from the group consisting of TiO₂, LiO₂, BaO, MgO, SiO₂, Al₂O₃, PTFE (polytetrafluoroethylene), ceramics, and a mixture thereof,

wherein the filling agent is suspended in the polymer solution forming a homogenous suspension formulation with the polymer solution, and

wherein the filling agent has a weight percentage greater than 0 wt % but less than 30 wt % of the suspension formulation.

In some embodiments, optionally in combination with any or all the various embodiments of the article disclosed herein, the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

In some embodiments, optionally in combination with any or all the various embodiments of the article disclosed herein, the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF.

In some embodiments, optionally in combination with any or all the various embodiments of the article disclosed herein, the coating is formed on one side or both sides of the cathode, the nanofibers being connected via 4 edges of the cathode surface; and wherein the layer of the nanofibers has a bulk volume porosity in a range of from about 40 to about 90%.

In some embodiments, optionally in combination with any or all the various embodiments of the article disclosed herein, the coating has a thickness in a range from about 5 m to about 50 μm.

In some embodiments, optionally in combination with any or all the various embodiments of the article disclosed herein, the article is an automobile, a portable electronic device such as a smart phone, a wearable watch, a notepad such as iPad, a computer, a medical device, an implantable device, wearable equipment, a robot, or an energy storage device other than battery.

### Examples

The following examples illustrate, rather than limit, the scope of the various embodiments disclosed herein.

Nanofiber coatings were made onto electrodes and LIBs were constructed therefrom according to the general methods and description of embodiments above. Details of materials used to form the nanofiber coating, methods used to form the coating, batteries formed therefrom, and tests on the coating and battery performances are described below.

Studies were undertaken on the following subjects associated with nanofiber coating on an electrode, namely, material of choice for forming nanofiber coatings on electrode, coating surface to determine structural properties of nanofiber coatings on electrode, e.g., porosity, including volume and size of pores, and mechanical strength and structural integrity of nanofiber coatings on electrode, via material spinning and SEM images, spinning technology and compression to determine whether electrospinning technology is capable of generating nanofiber coatings on electrodes, mix penetration tests with control separator, nanofiber coated electrode, with polymer alone or polymer together with a ceramic filling agent, and nanofiber coated electrode with a single polymer or dual polymer. These studies were made to determine a polymer material with or without filling agents is suitable for forming a nanofiber coating on an electrode, and if so, performance of a nanofiber coating on an electrode and performance of a battery formed therefrom.

Three different spinning methodologies were used to verify and/or fabricate the separator free design of LIB. Such electrospinning technology includes precursor spinning, Co-spinning (dual material), and layer-by-layer spinning (dual material).

As used herein, the term “precursor spinning” forming a nanofiber coating on a substrate by electrospinning a precursor to a polymer forming nanofibers on substrate and then forming nanofibers of the polymer. In this context, the precursor can also include a precursor for ceramic, e.g., a precursor for forming an inorganic ceramic as described previously. Co-spinning of dual material polymers refers to electrospinning a solution of the dual materials on a substrate to form nanofiber coating on the substrate. Layer-by-layer spinning of dual material refers to electrospinning one of the dual material to form first layer of nanofiber coating on the substrate and then electrospinning the other of the dual material to form a second layer of nanofiber coating on top of the first layer.

Nanofiber coatings were formed and shown in FIG. 5, which shows that nanofibers are still clearly observed and pores remain.

Mix penetration tests were performed to measure mix penetration strength of the nanofiber coating, which is the force required to create a short through a separator due to mix (electrode material). The mix penetration test measures the tendency of a separator to allow short circuits during battery assembly, short circuits created by e.g., particles penetration. In the test, the measurement would immediately be stopped when the short circuit occurs (speed: 0.1 mm/min).

Mix penetration tests were also performed by nanofiber coated electrode, coated with polymer/ceramic precursor.

LIBs with nanofiber coated electrode were constructed. Battery performance was tested on each battery. The results are shown in the table below (Table 3).

Studies of battery fabrication with NF coated electrode were performed as follows.

### Nanofiber Materials:

### PVDF/PVDF-HFP: PVDFs;

PVDF/PVDF-HFP/1 wt % TMOS: PVDFt-1 (weight percentage of TMOS in the total weight of the polymer and TMOS is 1%);
PVDF/PVDF-HFP/25 wt % TMOS: PVDFt-25 (weight percentage of TMOS in the total weight of the polymer and TMOS is 25%); and

### Polyimide: PI

General

Material studies were performed to determine air permeability & porosity, dimension stability (data not shown) and GSM (gram per square meter) (data not shown). Materials were then chosen to form nanofiber coatings on an electrode. Batteries were then constructed using the nanofiber coated electrode(s). Preliminary battery performance evaluation was performed on C-rate, self-discharge, and long cycling. All the studies were performed according to established methodologies.

The summery of studies are provided in Tables 3-8, below.

TABLE 3
Summary results of air permeability and porosity of electrospun nanofibers

| Sample No. | Materials | Thickness | | Remarks | Side | Air perm. (300 cc) | Porosity |
|---|---|---|---|---|---|---|---|
| 1 | Co-spinning of | 25.5 | μm | Without hot press | Side B | 3.0 ± 0.2 s | 86.65% |
| | PVDFt-1/PI | | | | | | |
| 2 | | 27 | μm | hot press 85° C. | | 3.9 ± 0.2 s (+30%) | 85.32% |
| | | | | for 85 mins | | | |
| 3 | PVDFt-25 | 13 | μm | Without hot press | | 6.2 ± 0.0 s | 85.74% |
| | | 13 | μm | hot press 85° C. | | 7.0 ± 0.0 s (+13%) | 79.23% |
| | | | | for 85 mins | | | |

TABLE 4
Summary of results of battery performance studies

| | | | | | Impedance (mΩ) | |
|---|---|---|---|---|---|---|
| | | | NF Thickness | | After | After |
| Sample No. | Cell No. | Solution | (um/side) | Before | hot press | formation |
| 4 | P77-2A | Co-spinning | 19.8 | 59.7 | X HP | 85.8 |
| P77 | | PI/PVDFt-1 | | | | |
| (x HP) | | | | | | |
| 5 | P79-2A | Co-spinning | 25.5 | 61.8 | 59.3 | 86.8 |
| P79 | | PI/PVDFt-1 | | | | |
| 6 | PVDFt1625- | PVDFt-25 | 13 | 64.23 | 57.86 | 88.08 |
| PVDFH625 | 19 | | | | | |
| 7** | | | | 80.7 | 79 | 114.6 |
| 10 μm w/ | Commercial | — | 10 | | | |
| ceramics | separator-9 | | | | | |
| | Commercial | | | 78.3 | 73.2 | 101.7 |
| | separator-12 | | | | | |

| | Battery thickness (mm) | | | Discharge | |
|---|---|---|---|---|---|
| | | After | After 2^{nd} seal | capacity | Capacity |
| | | hot | (in mm) | (10^{th} | density |
| Sample No. | Before | press | (thickness*L*W) | cycle) | (Wh/L) |
| 4 | 4.85 | XHP | 4.81*37.61*9.3 | 185.2 | 473.3 |
| P77 | | | (−0.8%) | | |
| (x HP) | | | | | |
| 5 | 5.02 | 4.72 | 4.94*38.05*9.47 | 189.3 | 457.3 |
| P79 | | (−6%) | (−1.6%) | | |
| 6 | 4.28 | 3.83 | 4.21*38.17*10.42 | 168.5 | 444.3 |
| PVDFH625 | | (−10.5%) | (−1.6%) | | |
| 7** | 4.67 | 4.75 | 4.8*38.16*9.43 | 185.4 | 461.5 |
| | | (+1.7%) | (+2.8%) | | |
| 10 μm w/ | 4.90 | 4.74 | 5.05*38.38*9.02 | 187.8 | 461.9 |
| ceramics | | (−3.3%) | (+3.1%) | | |

*HP: hot press
**control

It can be seen from the results in Table 3 that: i) air permeability of the nanofiber layers is slightly weaker after hot press, which indicate that (i.e. take longer time for air to pass through); ii) air permeability of 10 μm ceramic commercial separator: 118 s±5.3 s (for 100 cc air); iii) porosity of these nanofibers slightly decrease after hot press, which is consistent with the observation on air permeability; and iv) co-spinning of PVDFt-1/PI has a higher air permeability, possibly due to the fluffiness of PI and lower TMOS content than PVDFt-25.

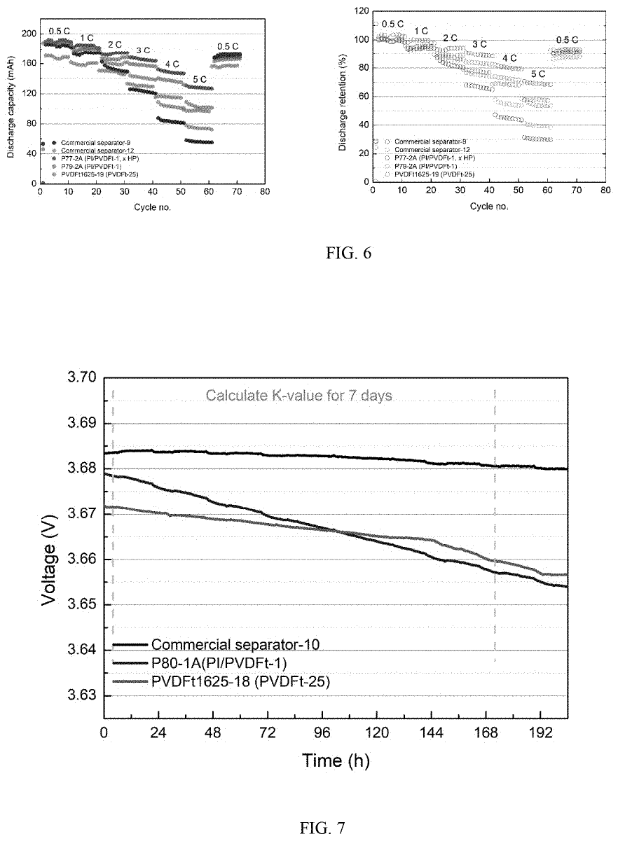

Battery performance studies on impedance, battery thickness and discharging capacity were performed, the results of which are summarized in Table 4 and FIG. 6.

From Table 4 and FIG. 6, the following two observations can be made: i) all nanofiber coating batteries show decrease in size after 2nd seal and remain low impedance; and ii) there is an obvious difference between separator-free battery and battery with commercial separator, especially at high C-rate.

Studies on discharge capacity at different C-rates were made. The results are summarized in Table 5, which show that compared with the controls (Cell Nos. 11 and 12), separator fee batteries of the present invention are superior, especially at high C-rates.

Studies on impedance, battery thickness and discharging capacity were also performed. The results are summarized in Table 6, which show that separator fee batteries have lower impedance and higher capacity density than control (Cell No. 15).

TABLE 5
Summary of discharge capacity at different C-rates.

| | | | Discharge | 0.5 C | | 1 C | | 2 C |
|---|---|---|---|---|---|---|---|---|
| | | NF | capacity | Avg | Avg. | Avg | Avg. | Avg |
| | | Thickness | (10^{th} | discharge | retention | discharge | retention | discharge |
| Cell No. | Solution | (μm/side) | cycle) | Cap. | % | Cap. | % | Cap. |
| 8 | Co- | 19.8 | 185.2 | 190.5 | 102.9 | 183.8 | 99.3 | 173.5 |
| P77-2A | spinning | | | | | | | |
| (x HP*) | PI/PVDFt-1 | | | | | | | |
| 9 | Co- | 25.5 | 189.3 | 189.1 | 99.9 | 180.1 | 95.1 | 166.6 |
| P79-2A | spinning | | | | | | | |
| | PI/PVDFt-1 | | | | | | | |
| 10 | PVDFt-25 | 13 | 168.5 | 170.6 | 101.2 | 159.7 | 94.8 | 148.9 |
| PVDFt | | | | | | | | |
| 1625-19 | | | | | | | | |
| 11** | | 10 | 185.4 | 184.6 | 99.6 | 173.8 | 93.7 | 153.2 |
| Commercial | | | | | | | | |
| separator-9 | | | | | | | | |
| 12** | | 10 | 187.8 | 187.4 | 99.8 | 178.2 | 94.9 | 160.5 |
| Commercial | | | | | | | | |
| separator-12 | | | | | | | | |
| | | 2 C | 3 C | | 4 C | | 5 C | |
| | | Avg. | Avg | Avg. | Avg | Avg. | Avg | Avg. |
| | | retention | discharge | retention | discharge | retention | discharge | retention |
| | Cell No. | % | Cap. | % | Cap. | % | Cap. | % |
| | 8 | 93.7 | 165.7 | 89.4 | 148.7 | 80.3 | 128.1 | 69.2 |
| | P77-2A | | | | | | | |
| | (x HP*) | | | | | | | |
| | 9 | 88 | 157.8 | 83.4 | 137 | 72.4 | 103.3 | 54.6 |
| | P79-2A | | | | | | | |
| | 10 | 88.3 | 130.9 | 77.7 | 115.6 | 68.6 | 97.5 | 57.8 |
| | PVDFt | | | | | | | |
| | 1625-19 | | | | | | | |
| | 11** | 82.6 | 123.4 | v | 83.4 | v | 56.3 | v |
| | Commercial | | | 66.6 | | 45 | | 30.4 |
| | separator-9 | | | | | | | |
| | 12** | 85.5 | 141.1 | 75.1 | 103.4 | 55.1 | 74.6 | 39.7 |
| | Commercial | | | | | | | |
| | separator-12 | | | | | | | |

⁺ co-spinning PI/PVDFt-1;
*hot press;
**control

TABLE 6
Summary of studies on impedance, battery thickness and discharging capacity

| | | | | Impedance (mΩ) | | | Battery thickness (mm) | | | Discharge | |
|---|---|---|---|---|---|---|---|---|---|---|---|
| | | | NF | | After | | | After | After 2^{nd} seal | capacity | Capacity |
| | | | Thickness | | hot | After | | hot | (in mm) | (10^{th} | density |
| Sample No. | Cell no. | Solution | (μm/side) | Before | press | formation | Before | press | (thickness*L*W) | cycle) | (Wh/L |
| 13 | P80-1A | Co- | 27.0 | 58.6 | 58.2 | 84.2 | 5.07 | 4.64 | 4.52*37.84*9.35 | 185.7 | 499.3 |
| P80 | | spinning | | | | | | | | | |
| | | PI/PVDFt-1 | | | | | | | | | |
| 14 | PVDFt1625- | PVDFt-25 | 13.0 | 66.89 | 59.07 | 94.62 | 4.35 | 3.73 | 4.44*37.82*9.20 | 171.3 | 482.3 |
| PVDFt1625 | 18 | | | | | | | | | | |
| 15* | Commercial | — | 10.0 | 83.4 | 74.8 | 105.8 | 4.91 | 4.75 | 5.05*37.98*9.4 | 183.1 | v |
| 10 μm with | separator-10 | | | | | | | | | | 454.1 |
| ceramics | | | | | | | | | | | |

*control

Battery Performance—Self-Discharge Studies

Battery self-discharge studies were performed with initial voltage at 3.67 V, rest for 4 hrs and measure the voltage for one week or a month. The results are summarized in Table 7 and FIG. 7.

TABLE 7
Summary of self-discharge studies

| | | | Discharge rate |
|---|---|---|---|
| Cell No. | At 4^{th} hr | At 172^{nd} hr | (mV/hr) |
| 16 | 3.67842 | 3.6572 | 0.12631 |
| P80-1A | | | |
| 17 | 3.67162 | 3.65971 | 0.07089 |
| PVDFt25 | | | |

Results in Table 7 and FIG. 7 show that PVDFt1625-18 can achieve a self-discharge of less than 0.08 mV/hr.

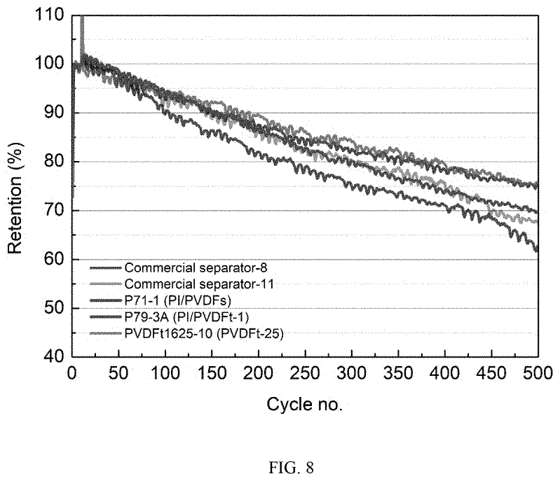

Long term battery performance studies up to 500 charge-discharge cycles were performed. The results are summarized in Table 8 and FIG. 8

TABLE 8
Results of long term battery performance studies.

| | | | | Impedance (mΩ) | | |
|---|---|---|---|---|---|---|
| | | | NF | Before | After | |
| | | | Thickness | hot | hot | After |
| Sample No. | Cell no. | Solution | (μm/side) | press | press | formation |
| 18 | P71-1 | Co- | 34 | 59.2 | 58.8 | 87.2 |
| P71 | | spinning | | | | |
| | | PI/PVDFs | | | | |
| 19 | P79-3A | Co- | 25.5 | 60.9 | 56.2 | 84.2 |
| P79 | | spinning | | | | |
| | | PI/PVDFt-1 | | | | |
| 20 | PVDFt1 | PVDFt-25 | 10 | 55.35 | 52.18 | 84.54 |
| PVDFe1625 | 625-10 | | | | | |
| 21° | Commercial | — | 10 | 79.6 | 75.0 | 103.2 |
| 10 μm with | separator -8 | | | | | |
| ceramics | Commercial | | | 80.2 | 74.3 | 102.2 |
| | separator-11 | | | | | |

| | Battery thickness (mm) | | | Discharge | | Retention |
|---|---|---|---|---|---|---|
| | | After | After 2^{nd} seal | capacity | Capacity | % at |
| | | hot | (in mm) | (10^{th} | density | 500^{th} |
| Sample No. | Before | press | (thickness*L*W) | cycle) | (Wh/L) | cycle |
| 18 | 4.69 | 4.18 | 4.53*37.83*10.45 | 176.1 | 422.8 | 70 |
| P71 | | | | | | |
| 19 | 5.01 | 4.66 | 4.97*37.70*9.34 | 190.1 | 467.1 | 75.4 |
| P79 | | | | | | |
| 20 | 4.33 | 4.03 | 4.50*37.97*10.56 | 188.2 | 448.5 | 75.6 |
| PVDFe1625 | | | | | | V |
| 21° | 4.61 | 4.4 | 4.8*37.85*9.68 | 184.9 | 452.1 | 62.8 |
| 10 μm with | 4.98 | 4.76 | 5.13*38.36*9.16 | 186.3 | 444.4 | 67.5 |
| ceramics | | | | | | |

*control

Results in Table 8 and FIG. 8 show that impedance of separator-free batteries remains lower than that of battery with 10 μm ceramics separator (Cell No. 21). Additionally, comparing to 10 μm with ceramics (manual winding, Cell No. 21), all separator-free batteries have better retention than them after 500th cycle.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. A lithium secondary battery, comprising a cathode comprising a cathode active material, an anode comprising an anode active material, and an electrolyte solution comprising a lithium salt, wherein a coating comprising a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

2. The lithium secondary battery according to claim 1, which is a separator-free battery that does not comprise a standalone separator.

3. The lithium secondary battery according to claim 1, wherein the coating is formed on the surface of both sides of the cathode, the anode, or both the cathode and the anode, and wherein the coating on the surface of one side of the cathode, the anode, or both the cathode and the anode is connected with the coating on the surface of the other side of the cathode, the anode, or both the cathode and anode via each edge of the cathode, the anode, or both the cathode and the anode.

4. The lithium secondary battery according to claim 1, wherein the coating is formed on one side or both side of both the cathode and the anode.

5. The lithium secondary battery according to claim 1, wherein the coating comprising the layer of fine polymer fibers is formed by depositing on the surface of cathode a melted polymer or polymer mixture or a solution of a polymer or polymer mixture in an organic solvent and allowing the melted polymer or polymer mixture to cool or the organic solvent to evaporate so as to form a coating comprising a layer of fine polymer fibers.

6. The lithium secondary battery according to claim 5, wherein the polymer solution further comprises an optional additive and a filling agent selected from the group consisting of TiO₂, LiO₂, BaO, MgO, SiO₂, Al₂O₃, PTFE (polytetrafluoroethylene), ceramics, and a mixture thereof,
wherein the filling agent is suspended in the polymer solution forming a homogenous suspension formulation with the polymer solution, and
wherein the filling agent has a weight percentage greater than 0 wt % but less than 30 wt % of the suspension formulation.

7. The lithium secondary battery according to claim 1, wherein the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

8. The lithium secondary battery according to claim 1, wherein the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF.

9. The lithium secondary battery according to claim 1, wherein the fine polymer fibers are nanofibers, wherein the coating is formed on one side or both sides of the cathode, the nanofibers being connected via 4 edges of the cathode surface; and
wherein the layer of the nanofibers has a bulk volume porosity in a range of from about 40 to about 90%.

10. The lithium secondary battery according to claim 1, wherein the coating has a thickness in a range from about 5 μm to about 50 μm.

11. A method of fabricating a lithium secondary battery, comprising:
providing a cathode comprising a cathode active material,
providing an anode comprising a anode active material,
providing an electrolyte solution comprising a lithium salt dissolved therein,
forming a coating comprising a layer of fine polymer fibers on a surface of the cathode, the anode, or both the cathode and anode, with the coating having an area larger than the surface of the cathode, anode, or both the cathode and anode, extending to each edge of the at least one side of the cathode, the anode, or both the cathode and the anode; and
forming the lithium secondary battery.

12. The method according to claim 11, wherein forming the coating further comprises hot pressing the layer of fine polymer fibers.

13. The method according to claim 11, wherein the polymer is a homopolymer, a copolymer, or a blend thereof, the polymer being formed from monomers selected from the group consisting of vinylidene fluoride, hexafluoropropylene (HFP), imide, acrylonitrile, and a combination thereof.

14. The method according to claim 11, wherein the polymer is selected from the group consisting of PVDF-HFP (polyvinylidene fluoride-co-hexafluoropropylene), a blend of PI/PAN (polyimide/polyacrylonitrile), a blend of PVDF/PI (polyvinylidene fluoride/polyimide), and a blend of PI/PAN/PVDF, and a blend of PI/PAN/PVDF.

15. The method according to claim 11, wherein the lithium secondary battery is according to claim 4.

16. The method according to claim 11, wherein the lithium secondary battery is according to claim 9.

17. An article of manufacture, comprising a lithium secondary battery, the lithium secondary battery comprising a cathode comprising a cathode active material, an anode comprising an anode active material, and an electrolyte solution comprising a lithium salt, wherein a coating comprising a layer of fine polymer fibers is formed on a surface of at least one side of the cathode, the anode, or both the cathode and the anode, with the coating having an area larger than the surface of the cathode, anode, or both the cathode and anode, extending to each edge of the at least one side of the cathode, the anode, or both the cathode and the anode.

18. The article of manufacture according to claim 17, wherein the lithium secondary battery is according to claim 4.

19. The article of manufacture according to claim 17, wherein the lithium secondary battery is according to claim 9.

20. The article of manufacture according to claim 17, which is an automobile, a portable electronic device, a computer, a medical device, an implantable device, wearable equipment, a robot, or an energy storage device other than battery.
